(19) United States
(12) Patent Application Publication
(10) Pub. No.: US 2024/0059870 A1
(43) Pub. Date: Feb. 22, 2024

(54) SMALL-SIZED CALCIUM CARBONATE PARTICLES IN NONWOVENS AND FILMS

(71) Applicant: Berry Global, Inc., Evansville, IN (US)

(72) Inventors: Frank Eschenbacher, Schnelldorf (DE); Robert Garcia Pano, Alcanar (ES)

(21) Appl. No.: 18/236,482

(22) Filed: Aug. 22, 2023

Related U.S. Application Data
(60) Provisional application No. 63/399,861, filed on Aug. 22, 2022.

(51) Int. Cl. C08K 9/04; B32B 5/02; B32B 5/26; B32B 7/12; B32B 27/08; B32B 27/12; B32B 27/18; C08J 5/18

(52) U.S. Cl. CPC C08K 9/04; B32B 5/022; B32B 5/266; B32B 7/12; B32B 27/08; B32B 27/12; B32B 27/18; C08J 5/18; B32B 2262/02; B32B 2264/104; B32B 2264/302; B32B 2264/403; B32B 2307/7246; B32B 2307/7376; C08J 2323/00; C08J 2367/04; C08J 2377/00; C08K 2201/005

(57) ABSTRACT

Nonwovens, films, and composites thereof are provided, in which at least the nonwoven or film has a plurality of small-sized calcium carbonate (CaCO₃) particles having generally narrow distribution.

### CROSS-REFERENCE TO RELATED APPLICATIONS

This application claims priority under 35 U.S.C. § 119 to U.S. Patent Application No. 63/399,861 filed Aug. 22, 2022, which is expressly incorporated by reference herein in its entirety.

### TECHNICAL FIELD

Embodiments of the presently-disclosed invention relate generally to providing nonwovens, films, and composites thereof having a plurality of small-sized calcium carbonate (CaCO₃) particles having generally narrow distribution.

### BACKGROUND

A variety of films and nonwoven fabrics may be used alone or in combination for use in diverse range of applications, such as breathable and/or barrier applications or products. For instance, films and nonwoven fabrics are routinely used in the construction of hygiene products (e.g., diapers, femcare products, personal wipes, etc.); medical applications (e.g., medical gowns and drapes); and industrial applications (e.g., housewraps, roof linings, etc.). In applications that require cost-effective materials, for example, for moisture control (e.g., water vapor breathability) and/or barrier properties (e.g., alcohol and/or blood repellency), the use of films and nonwoven fabrics may be particularly desirable. In some instances, the manufacturing of these materials may employ the incorporation of filler materials (e.g., particles) that reduce the overall amount of polymeric material required to make the final product and/or play a key role in the formation of breathability, such as the case with microporous breathable films.

The use of calcium carbonate as a filler in films and nonwovens, however, may be undesirable due to the extra material costs, increased manufacturing complexity, and/or quality control issues associated with excessive dosing, spread, and/or agglomeration of the calcium carbonate within the materials being produced. For example, the use of calcium carbonate in microporous films may impair the balance between strength and breathability due to agglomeration of some of the calcium carbonate particles or when the particle size distribution includes too many large and/or fine particles such that the final film lacks proper uniformity in properties and/or composition. For instance, the current industry standard mean particle size for calcium carbonate when used as a filler is between about 1.2 to about 1.6 microns (e.g., D50 from 1.2 to 1.6), while also including a sizeable portion of particles exceeding 5 microns or more. For example, traditional calcium carbonate particle size distributions may have a D98 value from 5 to 10 microns. The presence of such large particles can lead to the formation of defects in the final product (e.g., film and/or nonwoven) as well as hinder manufacturing.

### SUMMARY OF INVENTION

One or more embodiments of the invention may address one or more of the aforementioned problems. Certain embodiments according to the invention provide a nonwoven fabric including a plurality of fibers comprising (i) a polymeric component, and (ii) an additive component comprising a plurality of calcium carbonate particles dispersed throughout the polymeric component. The plurality of calcium carbonate particles have a particle size distribution having a mean and/or median (D50) diameter from 0.3 to about 0.8 microns, such as at least about any of the following: 0.3, 0.35, 0.4, 0.45, and 0.5 microns, and/or at most about any of the following: 0.9, 0.85, 0.8, 0.75, 0.7, 0.65, and 0.6 microns.

In another aspect, the present invention provides a film including (i) a polymeric component, and (ii) an additive component comprising a plurality of calcium carbonate particles dispersed throughout the polymeric component. The plurality of calcium carbonate particles have a particle size distribution having a mean and/or median (D50) diameter from 0.3 to about 0.8 microns, such as at least about any of the following: 0.3, 0.35, 0.4, 0.45, and 0.5 microns, and/or at most about any of the following: 0.9, 0.85, 0.8, 0.75, 0.7, 0.65, and 0.6 microns.

In another aspect, the present invention provides a composite including a first nonwoven layer directly or indirectly bonded to a first film, in which at least one of the first nonwoven layer and the first film includes a respective additive component comprising a plurality of calcium carbonate particles dispersed throughout a respective polymeric component. The plurality of calcium carbonate particles have a particle size distribution having a mean and/or median (D50) diameter from 0.3 to about 0.8 microns, such as at least about any of the following: 0.3, 0.35, 0.4, 0.45, and 0.5 microns, and/or at most about any of the following: 0.9, 0.85, 0.8, 0.75, 0.7, 0.65, and 0.6 microns.

In another aspect, the present invention provides a method of forming a nonwoven fabric, such as those described and disclosed herein, comprising steps of (i) forming a polymeric melt including a polymeric component and an additive component comprising a plurality of calcium carbonate particles dispersed throughout the polymeric component, (ii) forming a plurality of fibers from the polymeric melt, and (iii) consolidating the plurality of fibers to form the nonwoven fabric.

In another aspect, the present invention provides a method of forming a film, such as those described and disclosed herein, comprising steps of (i) forming a polymeric melt including a polymeric component and an additive component comprising a plurality of calcium carbonate particles dispersed throughout the polymeric component, and (ii) extruding the polymeric melt into a film.

In yet another aspect, the present invention provides a method of forming a composite, such as those described and disclosed herein, comprising steps of directly or indirectly bonding a first nonwoven layer to a first film, wherein at least one of the first nonwoven layer or the first film include a plurality of calcium carbonate particles having a particle size distribution having a mean and/or median (D50) diameter from 0.3 to about 0.8 microns, such as at least about any of the following: 0.3, 0.35, 0.4, 0.45, and 0.5 microns, and/or at most about any of the following: 0.9, 0.85, 0.8, 0.75, 0.7, 0.65, and 0.6 microns.

### DETAILED DESCRIPTION

The invention now will be described more fully hereinafter. Indeed, this invention may be embodied in many different forms and should not be construed as limited to the embodiments set forth herein; rather, these embodiments are provided so that this disclosure will satisfy applicable legal requirements. As used in the specification, and in the appended claims, the singular forms “a”, “an”, “the”, include plural referents unless the context clearly dictates otherwise.

The presently-disclosed invention relates generally to the use of a mineral particulate comprising an alkaline earth metal carbonate, such as calcium carbonate, having a notably smaller average particle size compared to traditional fillers (e.g., average particle size from 1.2-1.6 microns) in the formation of nonwoven fabrics, films, and composites. The use of the small-sized calcium carbonate particles, in accordance with certain embodiments of the invention, my provide products (e.g., nonwoven fabrics, films, and composites) having improved uniformity and/or physical properties, such as machine direction (MD) and cross direction (CD) tensile strengths per basis weight relative to an identically constructed comparative product (e.g., nonwoven fabrics, films, and composites) differing in only the average size of the filler used therein.

The terms “substantial” or “substantially” may encompass the whole amount as specified, according to certain embodiments of the invention, or largely but not the whole amount specified (e.g., 95%, 96%, 97%, 98%, or 99% of the whole amount specified) according to other embodiments of the invention.

The terms “polymer” or “polymeric”, as used interchangeably herein, may comprise homopolymers, copolymers, such as, for example, block, graft, random, and alternating copolymers, terpolymers, etc., and blends and modifications thereof. Furthermore, unless otherwise specifically limited, the term “polymer” or “polymeric” shall include all possible structural isomers; stereoisomers including, without limitation, geometric isomers, optical isomers or enantionmers; and/or any chiral molecular configuration of such polymer or polymeric material. These configurations include, but are not limited to, isotactic, syndiotactic, and atactic configurations of such polymer or polymeric material. The term “polymer” or “polymeric” shall also include polymers made from various catalyst systems including, without limitation, the Ziegler-Natta catalyst system and the metallocene/single-site catalyst system. The term “polymer” or “polymeric” shall also include, in according to certain embodiments of the invention, polymers produced by fermentation process or biosourced.

The terms “nonwoven” and “nonwoven web”, as used herein, may comprise a web having a structure of individual fibers, filaments, and/or threads that are interlaid but not in an identifiable repeating manner as in a knitted or woven fabric. Nonwoven fabrics or webs, according to certain embodiments of the invention, may be formed by any process conventionally known in the art such as, for example, meltblowing processes, spunbonding processes, needle-punching, hydroentangling, air-laid, and bonded carded web processes. A “nonwoven web”, as used herein, may comprise a plurality of individual fibers that have not been subjected to a consolidating process.

The terms “fabric” and “nonwoven fabric”, as used herein, may comprise a web of fibers in which a plurality of the fibers are mechanically entangled or interconnected, fused together, and/or chemically bonded together. For example, a nonwoven web of individually laid fibers may be subjected to a bonding or consolidation process to bond at least a portion of the individually fibers together to form a coherent (e.g., united) web of interconnected fibers.

The term “consolidated” and “consolidation”, as used herein, may comprise the bringing together of at least a portion of the fibers of a nonwoven web into closer proximity or attachment there-between (e.g., thermally fused together, chemically bonded together, and/or mechanically entangled together) to form a bonding site, or bonding sites, which function to increase the resistance to external forces (e.g., abrasion and tensile forces), as compared to the unconsolidated web. The bonding site or bonding sites, for example, may comprise a discrete or localized region of the web material that has been softened or melted and optionally subsequently or simultaneously compressed to form a discrete or localized deformation in the web material. Furthermore, the term “consolidated” may comprise an entire nonwoven web that has been processed such that at least a portion of the fibers are brought into closer proximity or attachment there-between (e.g., thermally fused together, chemically bonded together, and/or mechanically entangled together), such as by thermal bonding or mechanical entanglement (e.g., hydroentanglement) as merely a few examples. Such a web may be considered a “consolidated nonwoven”, “nonwoven fabric” or simply as a “fabric” according to certain embodiments of the invention.

The term “staple fiber”, as used herein, may comprise a cut fiber from a filament. In accordance with certain embodiments, any type of filament material may be used to form staple fibers. For example, staple fibers may be formed from polymeric fibers, and/or elastomeric fibers. Non-limiting examples of materials may comprise polyolefins (e.g., a polypropylene or polypropylene-containing copolymer), polyethylene terephthalate, and polyamides. The average length of staple fibers may comprise, by way of example only, from about 2 centimeter to about 15 centimeter.

The term “spunbond”, as used herein, may comprise fibers which are formed by extruding molten thermoplastic material as filaments from a plurality of fine, usually circular, capillaries of a spinneret with the diameter of the extruded filaments then being rapidly reduced. According to an embodiment of the invention, spunbond fibers are generally not tacky when they are deposited onto a collecting surface and may be generally continuous as disclosed and described herein. It is noted that the spunbond used in certain composites of the invention may include a nonwoven described in the literature as SPINLACE®. Spunbond fibers, for example, may comprises continuous fibers.

As used herein, the term “continuous fibers” refers to fibers which are not cut from their original length prior to being formed into a nonwoven web or nonwoven fabric. Continuous fibers may have average lengths ranging from greater than about 15 centimeters to more than one meter, and up to the length of the web or fabric being formed. For example, a continuous fiber, as used herein, may comprise a fiber in which the length of the fiber is at least 1,000 times larger than the average diameter of the fiber, such as the length of the fiber being at least about 5,000, 10,000, 50,000, or 100,000 times larger than the average diameter of the fiber.

The term “meltblown”, as used herein, may comprise fibers formed by extruding a molten thermoplastic material through a plurality of fine die capillaries as molten threads or filaments into converging high velocity, usually hot, gas (e.g. air) streams which attenuate the filaments of molten thermoplastic material to reduce their diameter, which may be to microfiber diameter, according to certain embodiments of the invention. According to an embodiment of the invention, the die capillaries may be circular. Thereafter, the meltblown fibers are carried by the high velocity gas stream and are deposited on a collecting surface to form a web of randomly disbursed meltblown fibers. Meltblown fibers may comprise microfibers which may be continuous or discontinuous and are generally tacky when deposited onto a collecting surface. Meltblown fibers, however, are shorter in length than those of spunbond fibers.

The term “cellulosic fiber”, as used herein, may comprise fibers derived from hardwood trees, softwood trees, or a combination of hardwood and softwood trees prepared for use in, for example, a papermaking furnish and/or fluff pulp furnish by any known suitable digestion, refining, and bleaching operations. The cellulosic fibers may comprise recycled fibers and/or virgin fibers. Recycled fibers differ from virgin fibers in that the fibers have gone through the drying process at least once. In certain embodiments, at least a portion of the cellulosic fibers may be provided from non-woody herbaceous plants including, but not limited to, kenaf, cotton, hemp, jute, flax, sisal, or abaca. Cellulosic fibers may, in certain embodiments of the invention, comprise either bleached or unbleached pulp fiber such as high yield pulps and/or mechanical pulps such as thermo-mechanical pulping (TMP), chemical-mechanical pulp (CMP), and bleached chemical-thermo-mechanical pulp BCTMP. In this regard, the term “pulp”, as used herein, may comprise cellulose that has been subjected to processing treatments, such as thermal, chemical, and/or mechanical treatments. Cellulose fibers, according to certain embodiments of the invention, may comprise one or more regenerated cellulose fibers (e.g., viscose, rayon, Lyocell fibers, etc.). Cellulosic fibers, according to certain embodiments of the invention, may comprise one or more pulp materials.

The term “melt fibrillation”, as used herein, may comprise a general class of making fibers defined in that one or more polymers are molten and may be extruded into many possible configurations (e.g. co-extrusion, homogeneous or bicomponent films or filaments) and then fibrillated or fiberized into a plurality of individual filaments for the formation of melt-fibrillated fibers. Non limiting examples of melt-fibrillation methods may include melt blowing, melt fiber bursting, and melt film fibrillation. The term “melt-film fibrillation”, as used herein, may comprise a method in which a melt film is produced from a melt and then a fluid is used to form fibers (e.g., melt-film fibrillated fibers) from the melt film. Examples include U.S. Pat. Nos. 6,315,806, 5,183,670, 4,536,361, 6,382,526, 6,520,425, and 6,695,992, in which the contents of each are incorporated by reference herein to the extent that such disclosures are consistent with the present disclosure. Additional examples include U.S. Pat. Nos. 7,628,941, 7,722,347, 7,666,343, 7,931,457, 8,512,626, and 8,962,501, which describe the Arium™ melt-film fibrillation process for producing melt-film fibrillated fibers (e.g., having sub-micron fibers).

As used herein, the term “monolithic” film may comprise any film that is continuous and substantially free or free of pores (e.g., devoid of pores). In certain alternative embodiments of the invention, a “monolithic” film may comprise fewer pore structures than would otherwise be found in a microporous film. According to certain non-limiting example embodiments of the invention, a monolithic film may act as a barrier to liquids and particulate matter but allow water vapor to pass through. In addition, without intending to be bound by theory, by achieving and maintaining high breathability, it is possible to provide an article that is more comfortable to wear because the migration of water vapor through the laminate helps reduce and/or limit discomfort resulting from excess moisture trapped against the skin. A “monolithic” film, for example, may comprise a highly breathable polymer.

The term “highly breathable polymer”, as used herein, may comprise any polymer or elastomer that is selectively permeable to water vapor but substantially impermeable to liquid water and that can form a breathable film, for example, in which the polymer is capable of absorbing and desorbing water vapor and providing a barrier to aqueous fluids (e.g., water, blood, etc.). For example, a highly breathable polymer can absorb water vapor from one side of a film and release it to the other side of film, thereby allowing the water vapor to be transported through the film. As the highly breathable polymer can impart breathability to films, films formed from such polymers do not need to include pores (e.g., monolithic film). According to certain embodiments of the invention, “highly breathable polymer” may comprise any thermoplastic polymer or elastomer having a moisture vapor transmission rate (MVTR) of at least 500 g/m²/day when formed into a film. According to certain embodiments of the invention, “highly breathable polymer” may comprise any thermoplastic polymer or elastomer having a MVTR of at least 750 g/m²/day or of at least 1000 g/m²/day when formed into a film, such as a film having, for example, a thickness of about 25 microns or less. According to certain embodiments of the invention, highly breathable polymers may comprise, for example, any one or combination of a polyether block amide copolymer (e.g., PEBAX® from Arkema Group), polyester block amide copolymer, copolyester thermoplastic elastomer (e.g., ARNITEL® from DSM Engineering Plastics, HYTREL® from E.I. DuPont de Nemours and Company), or thermoplastic urethane elastomer (TPU).

The term “microporous” film, as used herein, may comprise a polymeric film layer hiving a plurality of micropores dispersed throughout a body of the film. Microporous films, for example, may generally be produced by dispersing finely divided particles of a non-hygroscopic filler material, such as an inorganic salt (e.g., calcium carbonate), into a suitable polymer followed by forming a film of the filled polymer and stretching the film to provide good porosity and water vapor absorption or transmission. For example, microporous film breathability may be dependent on the formation of a tortuous porous path throughout the film via the stretching of the filler impregnated film to impart the desired porosity (e.g., pore formation). Furthermore, the barrier properties of such microporous films are affected by the surface tension of the liquid to which they are exposed (e.g., they are more easily penetrated by isopropyl alcohol than by water), and they transmit odor more easily than solid films (e.g., monolithic films).

The term “layer”, as used herein, may comprise a generally recognizable combination of similar material types and/or functions existing in the X-Y plane.

All whole number end points disclosed herein that can create a smaller range within a given range disclosed herein are within the scope of certain embodiments of the invention. By way of example, a disclosure of from about 10 to about 15 includes the disclosure of intermediate ranges, for example, of: from about 10 to about 11; from about 10 to about 12; from about 13 to about 15; from about 14 to about 15; etc. Moreover, all single decimal (e.g., numbers reported to the nearest tenth) end points that can create a smaller range within a given range disclosed herein are within the scope of certain embodiments of the invention. By way of example, a disclosure of from about 1.5 to about 2.0 includes the disclosure of intermediate ranges, for example, of: from about 1.5 to about 1.6; from about 1.5 to about 1.7; from about 1.7 to about 1.8; etc.

Certain embodiments according to the invention provide a nonwoven fabric including a plurality of fibers comprising (i) a polymeric component, and (ii) an additive component comprising a plurality of calcium carbonate particles dispersed throughout the polymeric component. The plurality of calcium carbonate particles have a particle size distribution having a mean and/or median (D50) diameter from 0.3 to about 0.8 microns, such as at least about any of the following: 0.3, 0.35, 0.4, 0.45, and 0.5 microns, and/or at most about any of the following: 0.9, 0.85, 0.8, 0.75, 0.7, 0.65, and 0.6 microns.

In accordance with certain embodiments of the invention, the particle size distribution may have a D98 value of no more than 3 microns, such no more than any of the following: 3, 2.5, 2, 1.8, 1.5, 1.2, and 1 microns. Additionally or alternatively, the particle size distribution may have a D10 value from 0.05 to 0.25 microns, such as at least about any of the following: 0.05, 0.08, 0.1, and 0.12 microns, and/or at most about any of the following: 0.25, 0.22, 0.2, 0.18, 0.16, 0.15, 0.14, and 0.12 microns. Additionally or alternatively, the particle size distribution may have a standard deviation from about 0.05 to about 0.3 microns, such as least about any of the following: 0.05, 0.075, and 0.1 microns, and/or at most about any of the following: 0.3, 0.25, 0.2, 0.15, and 0.1 microns.

In accordance with certain embodiments of the invention, the plurality of calcium carbonate particles may comprise a coating thereon. For example, the coating may comprise a fatty acid, such as stearic acid, or acrylonitrile styrene acrylate. The coating, for instance, may facilitate a more uniform distribution of the plurality of calcium carbonate particles throughout the polymeric component, which may facilitate the formation of a more uniform (e.g., appearance and/or physical properties) product (e.g., nonwoven fabric). The coating, for example, may comprises from about 0.1 to about 3% by weight of the plurality of calcium carbonate particles, such as at least about any of the following: 0.1, 0.3, 0.05, 0.8, 1, 1.2, 1.4, and 1.5% by weight, and/or at most about any of the following: 3, 2.8, 2.5, 2.2, 2, 1.8, 1.6, and 1.5% by weight.

In accordance with certain embodiments of the invention, the plurality of calcium carbonate particles may comprise from about 3 to about 40% by weight of the plurality of fibers, such as at least about any of the following: 3, 5, 6, 8, 10, 12, 15, 18, and 20% by weight of the plurality of fibers, and/or at most about any of the following: 40, 38, 35, 32, 30, 28, 25, 22, and 20% by weight of the plurality of fibers.

In accordance with certain embodiments of the invention, the plurality of fibers may comprise spunbond fibers, meltblown fibers, or staple fibers. In accordance with certain embodiments of the invention, the plurality of fibers comprise spunbond fibers having an average diameter from about 10 to about 30 microns, such as at least about any of the following: 10, 12, 15, 18, and 20 microns, and/or at most about any of the following: 30, 28, 25, 22, and 20 microns. In accordance with certain embodiments of the invention, the plurality of fibers comprise meltblown fibers having an average diameter from about 5 to about 12 microns, such as at least about any of the following: 5, 6, 7, and 8 microns, and/or at most about any of the following: 12, 11, 10, 9, and 8 microns.

The nonwoven fabric, in accordance with certain embodiments of the invention, may further comprises a plurality of cellulosic fibers, such as natural cellulosic fibers and/or regenerated cellulosic fibers (e.g., viscose, rayon, Lyocell fibers, etc.). For example, the nonwoven fabric may comprise a coform comprising the plurality of fibers and the plurality of cellulosic fibers intermixed with each other. Alternatively, the nonwoven fabric may be mechanically consolidated (e.g., hydroentangled, needle-punched, etc.) layers of one or more layers of the plurality of fibers (e.g., containing the plurality of calcium carbonate particles) and one or more layers of cellulosic fibers. In accordance with certain embodiments of the invention, the plurality of cellulosic fibers may comprise from about 10 to about 90% by weight of the nonwoven fabric, such as at least about any of the following: 10, 15, 20, 25, 30, 35, 40 and 45% by weight of a total fiber content of the nonwoven fabric, and/or at most about any of the following: 90, 85, 80, 75, 70, 65, 60, 55, 50, and 45% by weight of a total fiber content of the nonwoven fabric. Additionally or alternatively, the plurality of plurality of fibers comprise from about 10 to about 90% by weight of the nonwoven fabric, such as at least about any of the following: 10, 15, 20, 25, 30, 35, 40 and 45% by weight of a total fiber content of the nonwoven fabric, and/or at most about any of the following: 90, 85, 80, 75, 70, 65, 60, 55, 50, and 45% by weight of a total fiber content of the nonwoven fabric.

In accordance with certain embodiments of the invention, the nonwoven fabric includes a first nonwoven layer including the plurality of fibers comprising the plurality of calcium carbonate particles, a second layer comprising the plurality of cellulose fibers, and a third layer comprising a second nonwoven layer, wherein the second layer is located between the first layer and the second layer. The first layer, second layer, and third layer are mechanically consolidated together or thermally consolidated together.

In accordance with certain embodiments of the invention, the nonwoven fabric has one of the following structures:
(Structure 1) S1ₐ-M_{b};
(Structure 2) S1ₐ-M_{b}-S2_{c};
(Structure 3) S1ₐ-N_{d};
(Structure 4) S1ₐ-N_{d}-S2_{c};
(Structure 5) S1ₐ-M_{b}-N_{d}-S2_{c};
(Structure 6) S1ₐ-N_{d}-S3ₑ-N_{f}-52_{c};
(Structure 7) S1ₐ-N_{d}-M_{b}-N^{f}-S2_{c}
(Structure 8) S1ₐ-M_{b}-S3ₑ-M_{g}-S2_{c};
(Structure 9) S1ₐ-M_{b}-N_{d}-M_{g}-S2_{c}; or any combinations thereof;
wherein
‘M’ comprises a meltblown layer;
‘N’ comprises a melt-fibrillated fiber-containing layer;
‘S1’ comprises a first spunbond layer;
‘S2’ comprises a second spunbond layer;
‘S3’ comprises a third spunbond layer;
‘a’ represents the number of layers and is independently selected from 1, 2, 3, 4, and 5;
‘b’ represents the number of layers is independently selected from 0, 1, 2, 3, 4, and 5;
‘c’ represents the number of layers is independently selected from 1, 2, 3, 4, and 5;
‘d’ represents the number of layers is independently selected from 0, 1, 2, 3, 4, and 5;
‘e’ represents the number of layers is independently selected from 0, 1, 2, 3, 4, and 5;
‘f’ represents the number of layers is independently selected from 0, 1, 2, 3, 4, and 5; and
‘g’ represents the number of layers is independently selected from 0, 1, 2, 3, 4, and 5.
wherein one or more individual layers may comprise the plurality of calcium carbonate particles.

In accordance with certain embodiments of the invention, the polymeric component comprises a synthetic polymer, such as a polyolefin, a polyester, a polyamide, or any combination thereof. Additionally or alternatively, the polymer component may comprise one or more biosourced polymers, such as one or more polylactic acids. The polymeric component may comprise from about 0 to 100% by weight of one or more synthetic polymers, such as at least about any of the following: 1, 5, 10, 15, 2, 25, 30, 35, 40, 45, and 50% by weight, and/or at most about any of the following: 100, 95, 90, 85, 80, 75, 70, 65, 60, 55, and 50% by weight. Additionally or alternatively, the polymeric component may comprise from about 0 to 100% by weight of one or more biosourced polymers, such as at least about any of the following: 1, 5, 10, 15, 2, 25, 30, 35, 40, 45, and 50% by weight, and/or at most about any of the following: 100, 95, 90, 85, 80, 75, 70, 65, 60, 55, and 50% by weight.

The nonwoven fabric, in accordance with certain embodiments of the invention, has a basis weight from about 3 to about 500 gsm, such as at least about any of the following: 3, 5, 8, 10, 15, 20, 30, 50, 80, 100, 150, 200, and 250 gsm, and/or at most about any of the following: 500, 450, 400, 350, 300, 250, and 200 gsm.

In accordance with certain embodiments of the invention, the nonwoven fabric comprises a bond area from about 3 to about 50%, such as at least about any of the following: 3, 5, 8, 10, 12, 15, 18, 20, 22, and 25%, and/or at most about any of the following: 50, 45, 40, 35, 30, 28, and 25%. Alternatively, the nonwoven fabric is area bonded having a bond area of 100%. Additionally or alternatively, the nonwoven fabric may be mechanically consolidated.

In accordance with certain embodiments of the invention the nonwoven fabric has a three-dimensional (3D) image imparted into a first side and/or a second side of the nonwoven fabric. In accordance with certain embodiments of the invention, the 3D image comprises a 3D pattern on at least a first side of the nonwoven fabric (and usually on both outer sides of the nonwoven fabric) and includes a plurality of recessed portions in a z-direction relative to an imaginary central plane extending through the nonwoven fabric in an x-y plane that is perpendicular to the z-direction. Additionally or alternatively, the 3D image comprises a 3D pattern on a first side of the nonwoven fabric (and usually on both outer sides of the nonwoven fabric) and includes a plurality of elevated portions in a z-direction relative to an imaginary central plane extending through the nonwoven fabric in an x-y plane that is perpendicular to the z-direction.

In accordance with certain embodiments of the invention, the nonwoven fabric may include a plurality of apertures extending therethrough. The plurality of apertures may define an open area from about 3 to about 40%, such as at least about any of the following: 3, 5, 8, 10, 12, 15, 18, and 20%, and/or at most about any of the following: 40, 38, 35, 32, 30, 28, 25, 22, and 20%. Additionally or alternatively, the plurality of apertures ay have an average individual open area from about 0.008 mm 2 to about 7 mm 2, such as at least about any of the following: 0.008, 0.01, 0.15, 0.2, 0.3, 0.5, 0.8, 1, 1.5, 2, 2.5, and 3 mm 2, and/or at most about any of the following: 7, 6.5, 6, 5.5, 5, 4.5, 4, 3.5, and 3 mm 2. In accordance with certain embodiments of the invention, the plurality of apertures may be located within recessed portions of the nonwoven fabric.

In another aspect, the present invention provides a method of forming a nonwoven fabric, such as those described and disclosed herein, comprising steps of (i) forming a polymeric melt including a polymeric component and an additive component comprising a plurality of calcium carbonate particles dispersed throughout the polymeric component, (ii) forming a plurality of fibers from the polymeric melt, and (iii) consolidating the plurality of fibers to form the nonwoven fabric. In accordance with certain embodiments of the invention, the step of forming the plurality of fibers may comprise processing the polymeric melt through a spunbond process, a meltblown process, or a melt-fibrillation process. The plurality of fibers may be deposited directly or indirectly onto a moving belt for the formation of a nonwoven web and subsequently consolidated, such as by one or more of the consolidation operations noted herein, to form the nonwoven fabric.

In another aspect, the present invention provides a film including (i) a polymeric component, and (ii) an additive component comprising a plurality of calcium carbonate particles dispersed throughout the polymeric component. The plurality of calcium carbonate particles have a particle size distribution having a mean and/or median (D50) diameter from 0.3 to about 0.8 microns, such as at least about any of the following: 0.3, 0.35, 0.4, 0.45, and 0.5 microns, and/or at most about any of the following: 0.9, 0.85, 0.8, 0.75, 0.7, 0.65, and 0.6 microns. Additionally or alternatively, the particle size distribution has a D98 value of no more than 3 microns, such no more than any of the following: 3, 2.5, 2, 1.8, 1.5, 1.2, and 1 microns. Additionally or alternatively, the particle size distribution has a D10 value from 0.05 to 0.25 microns, such as at least about any of the following: 0.05, 0.08, 0.1, and 0.12 microns, and/or at most about any of the following: 0.25, 0.22, 0.2, 0.18, 0.16, 0.15, 0.14, and 0.12 microns. Additionally or alternatively, the particle size distribution has a standard deviation from about 0.05 to about 0.3 microns, such as least about any of the following: 0.05, 0.075, and 0.1 microns, and/or at most about any of the following: 0.3, 0.25, 0.2, 0.15, and 0.1 microns.

In accordance with certain embodiments of the invention, the plurality of calcium carbonate particles may comprise a coating thereon. For example, the coating may comprise a fatty acid, such as stearic acid, or acrylonitrile styrene acrylate. The coating, for instance, may facilitate a more uniform distribution of the plurality of calcium carbonate particles throughout the polymeric component, which may facilitate the formation of a more uniform (e.g., appearance and/or physical properties) product (e.g., film). The coating, for example, may comprises from about 0.1 to about 3% by weight of the plurality of calcium carbonate particles, such as at least about any of the following: 0.1, 0.3, 0.05, 0.8, 1, 1.2, 1.4, and 1.5% by weight, and/or at most about any of the following: 3, 2.8, 2.5, 2.2, 2, 1.8, 1.6, and 1.5% by weight.

In accordance with certain embodiments of the invention, the plurality of calcium carbonate particles may comprise from about 3 to about 40% by weight of the film, such as at least about any of the following: 3, 5, 6, 8, 10, 12, 15, 18, and 20% by weight of the film, and/or at most about any of the following: 40, 38, 35, 32, 30, 28, 25, 22, and 20% by weight of the film. Additionally or alternatively, the film comprises a thickness from about 3 to about 200 microns, such as at least about any of the following: 3, 4, 5, 6, 7, 8, 9, 10, 20, 30, 40, 50, 60, 80, and 100 microns, and/or at most about any of the following: 200, 180, 160, 150, 140, 120, and 100 microns, and or the film comprises a basis weight from about 5 to about 100 gsm, such as at least about any of the following: 5, 8, 10, 15, 20, 25, 30, 35, 40, 45, and 50 gsm, and/or at most about any of the following: 100, 90, 80, 70, 60, and 50 gsm.

In accordance with certain embodiments of the invention, the film comprises a single-layer film. In accordance with certain embodiments of the invention, the film may comprise a single-layer film that is a monolithic film comprising at least one highly breathable polymer. The highly breathable polymer(s), in accordance with certain embodiments of the invention, may comprise at least one of a thermoplastic urethane (TPU), a polyether block amide copolymer (e.g., PEBAX® from Arkema Group or Vetsamid® E from Evonik), or a copolyester thermoplastic elastomer (e.g., ARNITEL® from DSM Engineering Plastics, HYTREL® from E.I. DuPont de Nemours and Company). The film, in accordance with certain embodiments of the invention, may comprise a polyether-block-ester copolymer including (i) soft blocks comprising polyethylene glycol and (ii) hard blocks comprising polybutylterephthalate. The film, in accordance with certain embodiments of the invention, may comprises a copolymer of isotactic polypropylene microcrystalline regions and random amorphous regions. Alternatively or additionally, the film may comprise a single-layer film that is a microporous film. Microporous films may generally be produced by dispersing finely divided particles of a non-hygroscopic filler material, such as an inorganic salt (e.g., calcium carbonate), into a suitable polymer followed by forming a film of the filled polymer and stretching the film to provide good porosity and water vapor absorption or transmission. In accordance with certain embodiments of the invention, the film may comprise a polyolefin, such as a polyethylene or a polypropylene, or a copolymer comprising a first polyolefin, such as a first polyethylene, and a second polyolefin, such as a second polypropylene.

In accordance with certain embodiments of the invention, the film may comprise a multi-layer film. The multi-layer film may include, for example, from 2 to about 10 individual film layers, such as at least about any of the following: 2, 3, 4, and 5 individual film layers, and/or at most about any of the following: 10, 9, 8, 7, 6, and 5 individual film layers. The multi-layer film may comprise, for example, at least a first skin layer and a core layer, wherein the first skin layer has a first thickness and the core layer has a second thickness in which the first thickness is less than the second thickness. The multi-layer film, in accordance with certain embodiments of the invention may comprises a second skin layer, wherein the core layer is located between the first skin layer and the second skin layer. In accordance with certain embodiments of the invention, at least one of the first skin layer and the core layer may comprise a microporous film layer. Additionally or alternatively, the core layer may comprise a monolithic film layer sandwiched between two skin layer, which may be microporous film layers or monolithic film layers.

In accordance with certain embodiments of the invention, at least one of the first skin layer, the second skin layer, and the core layer comprises a microporous film layer including the plurality of calcium carbonate particles. For example, at least one of the first skin layer and the second skin layer may comprise the plurality of calcium carbonate particles, and the core layer comprises a second plurality of calcium carbonate particles having a second particle size distribution having a mean and/or median (D50) diameter from 1 to about 3 microns, such as at least about any of the following: 1, 1.2, 1.4, 1.6, 1.8, and 2.0 microns, and/or at most about any of the following: 3, 2.8, 2.6, 2.4, 2.2, and 2 microns. In accordance with certain embodiments of the invention, the core layer comprises a monolithic film layer.

In accordance with certain embodiments of the invention, the film comprises has a moisture transmission vapor rate (MVTR) from at least about 400 g/m²/24 hr as determined according to ASTM Test Method E-96D, such as at least about any of the following: 400, 600, 800, 1000, 2000, 3000, 4000, 4500, 5000, 5500, 6000, 6500, 7000, 7500, and 8000 g/m²/24 hr as determined according to ASTM Test Method E-96D, and/or at most about any of the following: 12000, 11000, 10000, 9000, and 8000 g/m²/24 hr as determined according to ASTM Test Method E-96D.

In another aspect, the present invention provides a method of forming a film, such as those described and disclosed herein, comprising steps of (i) forming a polymeric melt including a polymeric component and an additive component comprising a plurality of calcium carbonate particles dispersed throughout the polymeric component, such as those described herein, and (ii) extruding the polymeric melt into a film (e.g., single-layer or multi-layer films). In accordance with certain embodiments of the invention, multilayer-films may be formed by extruding a plurality of respective polymeric melts, in which one or more (e.g., all) of the respective polymeric melts includes that small-sized calcium carbonate particles as described herein.

In another aspect, the present invention provides a composite including a first nonwoven layer directly or indirectly bonded to a first film, in which at least one of the first nonwoven layer and the first film includes a respective additive component comprising a plurality of calcium carbonate particles dispersed throughout a respective polymeric component. The plurality of calcium carbonate particles have a particle size distribution having a mean and/or median (D50) diameter from 0.3 to about 0.8 microns, such as at least about any of the following: 0.3, 0.35, 0.4, 0.45, and 0.5 microns, and/or at most about any of the following: 0.9, 0.85, 0.8, 0.75, 0.7, 0.65, and 0.6 microns. In accordance with certain embodiments of the invention, the first nonwoven layer may comprise a nonwoven fabric such as those described and disclosed herein and/or the first film may comprise a film such as those described and disclosed herein.

In accordance with certain embodiments of the invention, the first film may be thermally bonded directly to the first nonwoven layer. The first film, in accordance with certain embodiments of the invention, may be melt-extruded directly onto the first nonwoven layer. Alternatively, the composite may further comprise an adhesive layer located between and adhering the first nonwoven layer to the first film. The adhesive layer may have a basis weight from about 0.2 to about 5 gsm, such as at least about any of the following: 0.2, 0.4. 0.5, 0.6, 0.8, 1, 1.2. 1.4. 1.5, 1.6, 1.8, 2, 2.2, 2.4, and 2.5 gsm, and/or at most about any of the following: 5, 4.5, 4, 3.5, 3, and 2.5 gsm.

In accordance with certain embodiments of the invention, the composite has hydrostatic pressure resistance from at least about 500 cm per AATCC 127-1995, such as at least about any of the following: 500, 550, 600, 650, 700, 750, and 800 cm, and/or at most about any of the following: 1500, 1400, 1300, 1200, 1100, 1000, 900, and 800 cm. Additionally or alternatively, the composite may have a moisture transmission vapor rate (MVTR) from at least about 400 g/m²/24 hr as determined according to ASTM Test Method E-96D, such as at least about any of the following: 400, 600, 800, 1000, 2000, 3000, 4000, 4500, 5000, 5500, 6000, 6500, 7000, 7500, and 8000 g/m²/24 hr as determined according to ASTM Test Method E-96D, and/or at most about any of the following: 12000, 11000, 10000, 9000, and 8000 g/m²/24 hr as determined according to ASTM Test Method E-96D.

In accordance with certain embodiments of the invention, the composite may have a basis weight from about 10 to about 400 gsm, such as at least about any of the following: 10, 20, 30, 40, 50, 60, 70, 80, 90, 100, 110, 120, 130, 140, and 150 gsm, and/or at most about any of the following: 450, 420, 400, 380, 350, 320, 300, 280, 250, 220, 200, 180, 160, and 150 gsm. Additionally or alternatively, the composite may have a thickness from about 5 to about 50 mils, such as at least about any of the following: 5, 6, 8, 10, 12, 15, 18, and 20 mils, and/or at most about any of the following: 50, 45, 40, 35, 30, 25, and 20 mils.

In accordance with certain embodiments of the invention, the composite may have a machine direction trapezoidal tear resistance from about 20 to about 50 lbs per ASTM D5733, such as at least about any of the following: 20, 22, 25, 26, 28, and 30 lbs, and/or at most about any of the following: 50, 48, 45, 42, 40, 38, 36, 35, 34, 32, and 30 lbs. Additionally or alternatively, the composite may have a cross-direction trapezoidal tear resistance from about 20 to about 50 lbs per ASTM D5733, such as at least about any of the following: 20, 22, 25, 26, 28, and 30 lbs, and/or at most about any of the following: 50, 48, 45, 42, 40, 38, 36, 35, 34, 32, and 30 lbs.

In accordance with certain embodiments of the invention, the composite may have a machine direction breaking strength from about 50 to about 100 lbs per ASTM D5034, such as at least about any of the following: 50, 52, 55, 58, 60, 62, 65, and 70 lbs, and/or at most about any of the following: 100, 95, 90, 85, 80, 78, 75, 72, and 70 lbs. Additionally or alternatively, the composite may have a cross-direction breaking strength from about 50 to about 100 lbs per ASTM D5034, such as at least about any of the following: 50, 52, 55, 58, 60, 62, 65, and 70 lbs, and/or at most about any of the following: 100, 95, 90, 85, 80, 78, 75, 72, and 70 lbs.

In accordance with certain embodiments of the invention, a total film weight may account for about 5 to about 95% by weight of the composite, such as at least about any of the following: 5, 10, 15, 20, 25, 30, 35, 40, 45, and 50% by weight of the composite, and/or at most about any of the following: 95, 90, 85, 80, 75, 70, 65, 60, 55, and 50% by weight of the composite. Additionally or alternatively, a total nonwoven weight may account for about 5 to about 95% by weight of the composite, such as at least about any of the following: 5, 10, 15, 20, 25, 30, 35, 40, 45, and 50% by weight of the composite, and/or at most about any of the following: 95, 90, 85, 80, 75, 70, 65, 60, 55, and 50% by weight of the composite.

In yet another aspect, the present invention provides a method of forming a composite, such as those described and disclosed herein, comprising steps of directly or indirectly bonding a first nonwoven layer to a first film, wherein at least one of the first nonwoven layer or the first film include a plurality of calcium carbonate particles having a particle size distribution having a mean and/or median (D50) diameter from 0.3 to about 0.8 microns, such as at least about any of the following: 0.3, 0.35, 0.4, 0.45, and 0.5 microns, and/or at most about any of the following: 0.9, 0.85, 0.8, 0.75, 0.7, 0.65, and 0.6 microns. In accordance with certain embodiments of the invention, the composite may be activated by subjecting the composite to incremental stretching in the CD and/or MD.

In accordance with certain embodiments of the invention, first film may be melt extruded directly onto the first nonwoven layer. Alternatively, the first film and the first nonwoven layer may be formed separately and subsequently bonded together, such as thermally or adhesively bonded together.

In accordance with certain embodiments of the invention, the nonwoven fabric, films, and/or composites described and disclosed herein may be utilized or incorporated into a wide variety of end-products for a wide variety of functional applications. By way of example only, the nonwoven fabric, films, and/or composites described and disclosed herein may be utilized or incorporated into (i) hygiene products, for example, as a topsheet, acquisition distribution layer (ADL), a barrier leg cuff (BLC), a backsheet nonwoven, a corewrap, a dusting layer, ear panels for diapers; (ii) healthcare (medical) products, for example, as a surgical gown, surgical drape, curtains, and facemasks; and (iii) a variety of specialty segments, for example, as an agriculture crop cover, a housewrap, packaging materials (e.g., serializable packaging materials), liquid and/or air filtration media, wipes, and a tablecloth.

These and other modifications and variations to the invention may be practiced by those of ordinary skill in the art without departing from the spirit and scope of the invention, which is more particularly set forth in the appended claims. In addition, it should be understood that aspects of the various embodiments may be interchanged in whole or in part. Furthermore, those of ordinary skill in the art will appreciate that the foregoing description is by way of example only, and it is not intended to limit the invention as further described in such appended claims. Therefore, the spirit and scope of the appended claims should not be limited to the exemplary description of the versions contained herein.

That which is claimed:

1. A nonwoven fabric, comprising: a plurality of fibers comprising (i) a polymeric component, and (ii) an additive component comprising a plurality of calcium carbonate particles dispersed throughout the polymeric component, wherein the plurality of calcium carbonate particles has a particle size distribution having a mean and/or median (D50) diameter from 0.3 to about 0.8 microns, such as at least about any of the following: 0.3, 0.35, 0.4, 0.45, and 0.5 microns, and/or at most about any of the following: 0.9, 0.85, 0.8, 0.75, 0.7, 0.65, and 0.6 microns.

2. The nonwoven fabric of claim 1, wherein the particle size distribution has a D98 value of no more than 3 microns, a D10 value from 0.05 to 0.25 microns, or both.

3. The nonwoven fabric of claim 1, wherein the plurality of calcium carbonate particles comprise a coating thereon, wherein the coating comprises a fatty acid, such as stearic acid, or acrylonitrile styrene acrylate.

4. The nonwoven fabric of claim 3, wherein the coating comprises from about 0.1 to about 3% by weight of the plurality of calcium carbonate particles.

5. The nonwoven fabric of claim 1, wherein the plurality of calcium carbonate particles comprise from about 3 to about 40% by weight of the plurality of fibers.

6. The nonwoven fabric of claim 1, wherein the plurality of fibers comprise spunbond fibers, meltblown fibers, or staple fibers.

7. The nonwoven fabric of claim 1, wherein the nonwoven fabric has one of the following structures:
(Structure 1) S1ₐ-M_{b};
(Structure 2) S1ₐ-M_{b}-S2_{c};
(Structure 3) S1ₐ-N_{d};
(Structure 4) S1ₐ-N_{d}-S2_{c};
(Structure 5) S1ₐ-M_{b}-N_{d}-S2_{c};
(Structure 6) S1ₐ-N_{d}-S3ₑ-N_{f}-S2_{c};
(Structure 7) S1ₐ-N_{d}-M_{b}-N_{f}-S2_{c} (Structure 8) S1ₐ-M_{b}-S3ₑ-M_{g}-S2_{c};
(Structure 9) S1ₐ-M_{b}-N_{d}-M_{g}-S2_{c}; or any combinations thereof;
wherein
‘M’ comprises a meltblown layer;
‘N’ comprises a melt-fibrillated fiber-containing layer;
‘S1’ comprises a first spunbond layer;
‘S2’ comprises a second spunbond layer;
‘S3’ comprises a third spunbond layer;
‘a’ represents the number of layers and is independently selected from 1, 2, 3, 4, and 5;
‘b’ represents the number of layers is independently selected from 0, 1, 2, 3, 4, and 5;
‘c’ represents the number of layers is independently selected from 1, 2, 3, 4, and 5;
‘d’ represents the number of layers is independently selected from 0, 1, 2, 3, 4, and 5;
‘e’ represents the number of layers is independently selected from 0, 1, 2, 3, 4, and 5;
‘f’ represents the number of layers is independently selected from 0, 1, 2, 3, 4, and 5; and
‘g’ represents the number of layers is independently selected from 0, 1, 2, 3, 4, and 5.
wherein one or more individual layers may comprise the plurality of calcium carbonate particles.

8. The nonwoven fabric of claim 1, wherein the polymeric component comprises a polyolefin, a polyester, a polyamide, a polylactic acid, or any combination thereof.

9. A film, comprising: (i) a polymeric component, and (ii) an additive component comprising a plurality of calcium carbonate particles dispersed throughout the polymeric component, wherein the plurality of calcium carbonate particles has a particle size distribution having a mean and/or median (D50) diameter from 0.3 to about 0.8 microns, such as at least about any of the following: 0.3, 0.35, 0.4, 0.45, and 0.5 microns, and/or at most about any of the following: 0.9, 0.85, 0.8, 0.75, 0.7, 0.65, and 0.6 microns.

10. The film of claim 9, wherein the particle size distribution has a D98 value of no more than 3 microns, a D10 value from 0.05 to 0.25 microns, or both

11. The film of claim 9, wherein the plurality of calcium carbonate particles comprise a coating thereon, wherein the coating comprises a fatty acid, such as stearic acid, or acrylonitrile styrene acrylate, and wherein the coating comprises from about 0.1 to about 3% by weight of the plurality of calcium carbonate particles.

12. The film of claim 9, wherein the plurality of calcium carbonate particles comprise from about 3 to about 40% by weight of the film.

13. The film of claim 9, wherein the film comprises a thickness from about 3 to about 200 microns.

14. The film of claim 9, wherein the film comprises a single-layer film or a multi-layer film.

15. The film of claim 14, wherein the film is a multi-layer film and includes at least one first skin layer comprising the plurality of calcium carbonate particles, and a core layer comprises a second plurality of calcium carbonate particles having a second particle size distribution having a mean and/or median (D50) diameter from 1 to about 3 microns

16. A composite, comprising: a first nonwoven layer directly or indirectly bonded to a first film, wherein at least one of the first nonwoven layer and the first film includes a respective additive component comprising a plurality of calcium carbonate particles dispersed throughout a respective polymeric component, wherein the plurality of calcium carbonate particles has a particle size distribution having a mean and/or median (D50) diameter from 0.3 to about 0.8 microns, such as at least about any of the following: 0.3, 0.35, 0.4, 0.45, and 0.5 microns, and/or at most about any of the following: 0.9, 0.85, 0.8, 0.75, 0.7, 0.65, and 0.6 microns.

17. The composite of claim 16, wherein first film is thermally bonded directly to the first nonwoven layer.

18. The composite of claim 17, wherein the first film is melt-extruded directly onto the first nonwoven layer.

19. The composite of claim 16, further comprising an adhesive layer located between and adhering the first nonwoven layer to the first film.

20. The composite of claim 16, wherein the composite has (i) a hydrostatic pressure resistance from at least about 500 cm per AATCC 127-1995, (ii) a moisture transmission vapor rate (MVTR) from at least about 400 g/m²/24 hr as determined according to ASTM Test Method E-96D, or (iii) both (i) and (ii).
